(19) United States
(12) Patent Application Publication
(10) Pub. No.: US 2023/0152923 A1
(43) Pub. Date: May 18, 2023

(54) Palm Detection Using Multiple Types of Capacitance Measurements

(71) Applicant: Cirque Corporation, Sandy, UT (US)

(72) Inventor: Tyler Smith, American Fork, UT (US)

(73) Assignee: Cirque Corporation, Sandy, UT (US)

(21) Appl. No.: 17/528,711

(22) Filed: Nov. 17, 2021

(51) Int. Cl. G06F 3/044; G06F 3/041; G06F 3/0354

(52) U.S. Cl. CPC G06F 3/0445; G06F 3/04166; G06F 3/03547

(57) ABSTRACT

A touch sensor may include a substrate; a first set of electrodes and a second set of electrodes that are in communication with a capacitance controller; memory in communication with the capacitance controller where the memory includes programmed instructions that, when executed, cause the capacitance controller to take a first capacitance measurement using a first capacitance measurement technique capable of detecting an object within a first range; take a second capacitance measurement using a second capacitance measurement technique capable of detecting the object within a second range, wherein the second range is larger than the first range; and determine, based at least in part on both the first capacitance measurement and the second capacitance measurement, that an object is resting proximate the touch sensor.

### FIELD OF THE DISCLOSURE

This disclosure relates generally to systems and methods for palm detection. In particular, this disclosure relates to systems and methods for palm detection on touch surfaces.

### BACKGROUND

A touch pad and/or touch screen is often incorporated into laptops, tablets, mobile devices and other devices to provide a mechanism for giving inputs to the device. For example, a touch pad may be positioned adjacent to a keyboard in a laptop and include a surface that can be touched by the user. Touch pads may operate using capacitive sensing, a technology that senses the change of capacitance where a finger touches the pad. In some examples, the moving a finger, stylus, or another type of object adjacent or on the touch pad may cause a cursor to move on a display in communication with the touch pad. In some cases, a user may position his or her hands to use the keyboard while inadvertently resting the palms of his or her hands on the touch pad. Resting the palms on the touch pad may unintentionally cause the touch pad to register signals and have the potential to move the cursor on the screen or cause other inadvertent actions to take place.

An example of using a touch pad is disclosed in U.S. Pat. No. 8,970,552 issued to Chin-Fu Chang, et al. This reference discloses that self-capacitance detection can be performed by a sensing device. According to the result of the self-capacitance detection, a first mutual-capacitance detection can be performed for determining one or more first 1-D positions. According to the result of the first mutual-capacitance detection, a second mutual-capacitance detection can be performed for determining one or more second 1-D positions corresponding to each first 1-D position. One or more 2-D positions can be provided according to the one or more second 1-D positions corresponding to each first 1-D position. Besides, during the self-capacitance detection, the first mutual-capacitance detection, and the second mutual-capacitance detection, a touch related sensing information corresponding to a touch that covers a wide area can be neglected for palm rejection. This reference is herein incorporated by reference for all that it contains.

### SUMMARY

In one embodiment, a touch sensor may include a substrate; a first set of electrodes formed on a first layer of the substrate; a second set of electrodes formed on a second layer of the substrate, where the first set and second set are spaced apart and electrically isolated from each other; the first of electrodes and the second set of electrodes being in communication with a capacitance controller; memory in communication with the capacitance controller where the memory includes programmed instructions that, when executed, cause the capacitance controller to take a first capacitance measurement using a first capacitance measurement technique capable of detecting an object within a first range; take a second capacitance measurement using a second capacitance measurement technique capable of detecting the object within a second range, wherein the second range is larger than the first range; and determine, based at least in part on both the first capacitance measurement and the second capacitance measurement, that an object is resting proximate the touch sensor.

The programmed instructions, when executed, may cause the proximity controller to construct a first perspective profile of the object based on the first capacitance measurement technique, construct a second perspective profile of the object based on the second capacitance measurement technique, and analyze the first perspective profile to the second perspective profile to determine whether the object is resting proximate the touch sensor.

The first capacitance technique may be a mutual capacitance technique.

The second capacitance technique may be a self-capacitance technique.

Taking a self-capacitance measurement may include taking at least one measurement with at least one electrode from the first set of electrode and taking a self-capacitance measurement with at least one electrode from the set of electrodes.

The first set of electrodes may be configured to take a self-capacitance measurement in an X-direction and the second set of electrodes is configured to take a self-capacitance measurement in a Y-direction.

The programmed instructions, when executed, may cause the proximity controller to determine that signals from the object resting proximate the touch sensor is not involved in a touch input.

The programmed instructions, when executed, may cause the proximity controller to filter out signals from the object resting proximate the touch sensor.

The programmed instructions, when executed, may cause the proximity controller to inactivate at least a portion of the touch pad when the object is resting proximate the touch pad.

In one embodiment, a method of using a touch sensor may include taking a first capacitance measurement capable of detecting an object within a first range, constructing a first perspective profile of an affected area of the touch sensor influenced by an external object proximate to the touch sensor detected with the first capacitance measurement, taking a second capacitance measurement capable of detecting the object within a second range, wherein the second range is larger than the first range, construct a second perspective profile of the affected area of the touch sensor influenced by the external object proximate to the touch sensor detected with the second capacitance measurement, and determining the object is resting proximate the touch sensor based on the first capacitance measurement and the second capacitance measurement.

The first capacitance technique may be a mutual capacitance measurement that includes measuring capacitance at least one intersection between a first set of electrodes in a grid of the touch sensor and a second set of electrodes in the grid, where the first set of electrodes is formed on a first layer of a substrate and the second set of electrodes is formed on a second layer of the substrate and the first set of electrodes and the second set of electrodes are spaced apart from each other and electrically isolated from each other.

The second capacitance technique may be a self-capacitance measurement.

Taking the self-capacitance measurement may include taking at least one measurement with at least one electrode from the first set of electrode and taking a self-capacitance measurement with at least one electrode from the set of electrodes.

The first set of electrodes may be configured to take a self-capacitance measurement in an X-direction and the second set of electrodes is configured to take a self-capacitance measurement in a Y-direction.

The method may include determining that the object resting proximate the touch sensor is not involved in a touch input.

The method may include filtering out signals from the object resting proximate the touch sensor.

The method may include inactivating at least a portion of the touch pad when the object is resting proximate the touch pad.

A computer-program product for using a capacitance sensor may include a non-transitory computer-readable medium storing instructions executable by a processor to take a first capacitance measurement using a first capacitance measurement technique capable of detecting an object within a first range; take a second capacitance measurement using a second capacitance measurement technique capable of detecting the object within a second range where the second range is larger than the first range; and determine, based at least in part on both the first capacitance measurement and the second capacitance measurement, that an object is resting proximate the touch sensor.

The instructions may be executable by a processor to construct a first perspective profile of the object based on the first capacitance measurement technique, construct a second perspective profile of the object based on the second capacitance measurement technique, and use the first perspective profile and the second perspective profile to determine a coordinates of the object resting proximate the touch sensor.

The first capacitance technique may be a mutual capacitance technique, and the second capacitance technique may be a self-capacitance technique.

### BRIEF DESCRIPTION OF THE DRAWINGS

FIG. 1 depicts an example of a portable electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of electrodes energized in a mutual capacitance measuring technique in accordance with the disclosure.

FIG. 6 depicts an example of an electrode energized in a Y-direction self-capacitance measuring technique in accordance with the disclosure.

FIG. 7 depicts an example of an electrode energized in a X-direction self-capacitance measuring technique in accordance with the disclosure.

FIG. 8 depicts an example of hand placement over electrodes in a mutual capacitance measuring technique in accordance with the disclosure.

FIG. 9 depicts an example of a detection range in a mutual capacitance measuring technique in accordance with the disclosure.

FIG. 10 depicts an example of electrode intersections energized in a mutual capacitance measuring technique in accordance with the disclosure.

FIG. 11 depicts an example of hand placement over electrodes in a self-capacitance measuring technique in accordance with the disclosure.

FIG. 12 depicts an example of a detection range in a self-capacitance measuring technique in accordance with the disclosure.

FIG. 13 depicts an example of electrodes energized in a self-capacitance measuring technique in accordance with the disclosure.

FIG. 14 depicts an example of hand placement over electrodes in a mutual capacitance measuring technique in accordance with the disclosure.

FIG. 15 depicts an example of a detection range in a mutual capacitance measuring technique in accordance with the disclosure.

FIG. 16 depicts an example of electrode intersections energized in a mutual capacitance measuring technique in accordance with the disclosure.

FIG. 17 depicts an example of hand placement over electrodes in a self-capacitance measuring technique in accordance with the disclosure.

FIG. 18 depicts an example of a detection range in a self-capacitance measuring technique in accordance with the disclosure.

FIG. 19 depicts an example of electrodes energized in a self-capacitance measuring technique in accordance with the disclosure.

FIG. 20 depicts an example of a palm module in accordance with the disclosure.

FIG. 21 depicts an example of a method for detecting palm position in accordance with the disclosure.

FIG. 22 depicts an example of a method for detecting palm position in accordance with the disclosure.

FIG. 23 depicts an example of a method for detecting palm position in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “portable electronic device” may generally refer to devices that can be transported and include a battery and electronic components. Examples may include a laptop, a desktop, a mobile phone, an electronic tablet, a personal digital device, a watch, a gaming controller, a wearable device, another type of device, or combinations thereof.

It should be understood that use of the terms “touch pad” and “touch sensor” throughout this document may be used interchangeably with “capacitive touch sensor,” “capacitive sensor,” “capacitive touch and proximity sensor,” “proximity sensor,” “touch and proximity sensor,” “touch panel,” “trackpad”, “touch pad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

For the purposes of this disclosure, “moving proximate” the sensor may include the object touching and moving across an overlay, a keyboard cover, a housing, or another touch surface. The gaps between such touch surfaces and the sensor and/or the thickness of such overlays or other touch surfaces may cause the sensor to be spaced apart from the touch surface that the object can touch. In such examples, the overlay and/or other touch surfaces cause the object to be separated at least some distance from the sensor. In such an example, even when the object is touching the touch surface and/or the overlay, the object is still just proximate to the sensor since the object is still spaced at a distance away from the object even though the object is touching the touch surface. In other examples, being proximate to the touch surface may include examples where the object hovers over the touch surface and/or overlay such that the object does not come into physical contact with the touch surface and/or overlay. In such an example where the object hovers over the touch surface and/or overlay, the object may still be proximate to the touch sensor.

For the purposes of this disclosure, the term “self-capacitance measurement” may generally refer to a technique of obtaining a measurement with the use an electrode to measure capacitance between the electrode and ground of the touch sensor. In some examples, when the touch sensor is untouched or has an object in proximity to the sensor, the measured capacitance with the single electrode may represent a baseline self-capacitance measurement, and deviations from this measured capacitance may be used to detect the presence of an object within the capacitance sensor's proximity. In one example, a voltage may be applied to the electrode, then after discontinuing the voltage on the electrode, the same electrode may be used to measure the capacitance. When an electrically conductive object, such as a user's finger and/or stylus is in proximity to the touch sensor, the presence of such an object may affect the electrical field when the electrode is energized resulting in a different self-capacitance measurement.

In some examples, the capacitance sensor may include a grid of electrodes, with a first set of electrodes being aligned with each other and running in a first direction, and a second set of electrodes being aligned with each other and running in a second direction that is oriented transversely to the first set of electrodes. For the purposes of this disclosure, “Y-direction” may generally refer to the orientation of a first set of electrodes that are oriented in the first direction in such a grid of electrodes. For the purposes of this disclosure, “X-direction” may generally refer to the orientation a second set of electrodes that are oriented in second direction in such a grid of electrodes.

For the purposes of this disclosure, the term “mutual capacitance measurement” may generally refer to a technique of obtaining a measurement by energizing a first electrode with a voltage and measuring the capacitance from a second electrode. For the purposes of this disclosure, the term “electrode intersection” may generally refer to an overlap between the first electrode and the second electrode. In some cases, the first electrode is separated from the second electrode so that no electrical shorting occurs between the two electrodes. While the voltage is applied to the first electrode, the electric field around the first electrode is affected by the applied voltage. In those cases where the second electrode forms an intersection with the first electrode that is close enough to the first electrode, the electric field around the first electrode may be large enough to affect the space around the second electrode thereby changing the second electrode's electric field. Thus, when the measurement is taken with the second electrode, the resulting capacitance measurement is affected by the first electrode's applied voltage. In absences of a user finger or another electrically conductive object in proximity to the touch sensor, the measured capacitance may represent a baseline mutual capacitance measurement. When an electrically conductive object, such as a user finger and/or stylus is in proximity to the touch sensor, the presence of such an object may affect the electrical field when the first electrode is energized, thereby resulting in a different mutual capacitance being measured by the second electrode.

These different mutual capacitance measuring techniques may detect different types of information. For example, a self-capacitance measurement may have an ability to project farther away from the touch sensor (i.e., have a larger z-axis range) than a mutual capacitance measuring technique. Additionally, in some cases, a self-capacitance measurement technique may detect the presence of an object along the entire length of the electrode, whereas in some cases, the mutual capacitance measurement technique may only detect the presence of an object inter the intersection between the first and second electrodes.

For the purposes of this disclosure, the term “perspective profile” may generally refer to a profile of the object proximate to the touch sensor as perceived from the respective capacitance measuring technique. For example, in some examples, a first capacitance measuring technique may have a greater detection range (i.e., greater z-axis detection range) to detect the presence of an object. In such an example, the first capacitance measuring technique may be capable of sensing more of an object than another capacitance measuring technique is capable of sensing. In such a case, with the first capacitance measuring technique, the object may appear to have a larger size or a different shape than with a second capacitance measuring technique that has a shorter detection range. In such examples, the actual profile of the object does not change, but the perspective profile changes as different capacitance measuring techniques are capable of detecting different amounts of the same object. In some cases, the perspective profile may include a perspective shape, a perspective size, a perspective area, a perspective dimension, another perspective characteristic, or combinations thereof.

For the purposes of this disclosure, the term “resting” may generally refer to positioning an object in a relatively stationary position(s) with respect to the touch sensor. In some examples, making physical contact with a palm of a hand on the overlay or another touch surface proximate the touch sensor may be considered resting the palm proximate the touch sensor. In some examples, the palms of the hands may still be considered to be resting on the touch surface even though the palms may move short distances while still in contact with the touch surface as may be typical when a user is using his or her fingers to press keys on a keyboard. In another example, the palms may be considered to still be resting if the palms temporarily come up off of the contact surface. In yet another example, the palms may be considered to be resting with respect to the touch surface when the palms are merely hovering over the touch surface without making contact, but are still detectable by the touch sensor.

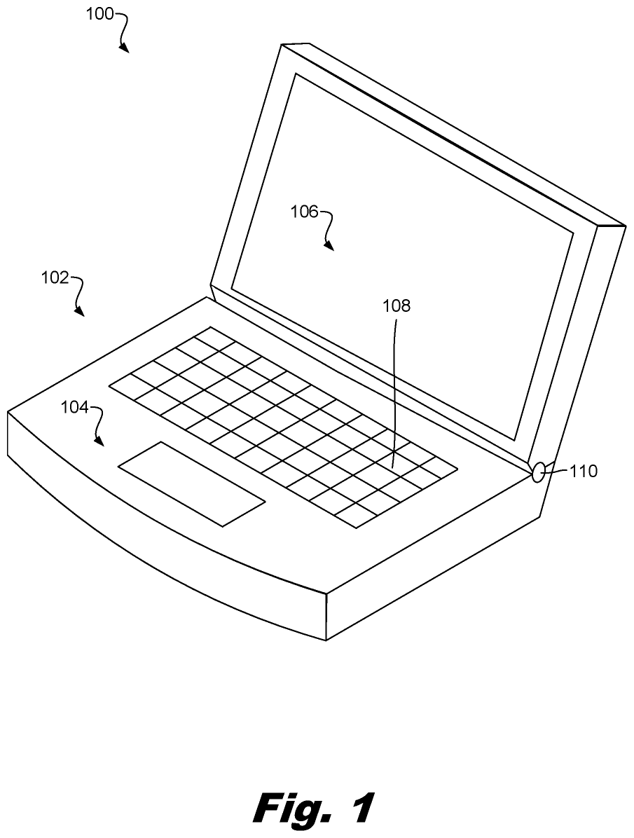

FIG. 1 depicts an example of a portable electronic device 100. In this example, the portable electronic device is a laptop. In the illustrated example, the portable electronic device 100 includes input components, such as a keyboard 102 and a touch pad 104. The portable electronic device 100 also includes a display 106. A program operated by the portable electronic device 100 may be depicted in the display 106 and controlled by a sequence of instructions that are provided by the user through the keyboard 102 and/or through the touch pad 104. An internal battery (not shown) may be used to power the operations of the portable electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 may include a capacitance sensor disposed underneath a surface containing the keyboard 102. In some examples, the touch pad 104 is located in an area of the keyboard's surface where the user's palms may rest while typing. The capacitance sensor may include a printed circuit board that includes a first layer of electrodes oriented in a first direction and a second layer of electrodes oriented in a second direction that is transverse the first direction. These layers may be spaced apart and/or electrically isolated from each other so that the electrodes on the different layers do not electrically short to each other. Capacitance may be measured at the overlapping intersections between the electrodes on the different layers. However, as the user's finger or other electrically conductive objects approach the intersections, the capacitance may change. These capacitance changes and their associated locations may be quantified to determine where the user is touching or hovering his or her finger within the area of the touch pad 104. In some examples, the first set of electrodes and the second set of electrodes are equidistantly spaced with respect to each other. Thus, in these examples, the sensitivity of the touch pad 104 is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 110. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may include a capacitance sensor that is located behind an outside surface of the display 106. As a user's finger or other electrically conductive object approaches the touch sensitive screen, the capacitance sensor may detect a change in capacitance as an input from the user.

While the example of FIG. 1 depicts an example of the portable electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, another type of portable electronic device, another type of device, or combinations thereof.

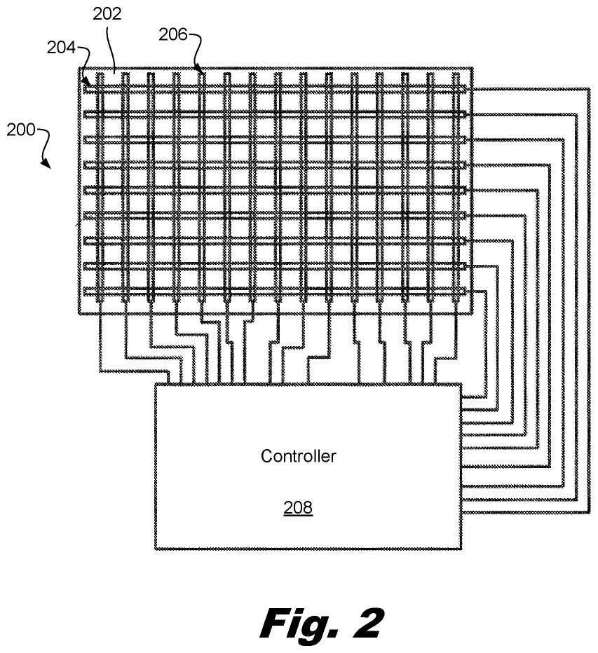

FIG. 2 depicts an example of a portion of a touch input component 200. In this example, the touch input component 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The touch input component 200 may include one or more electrodes in the first set 204 or the second set 206. Such a substrate 202 and electrode sets may be incorporated into a touch screen, a touch pad, and/or swell detection circuitry incorporated into a battery assembly.

In some examples, the touch input component 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the touch input controller 208 includes a touch controller 208. The touch controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

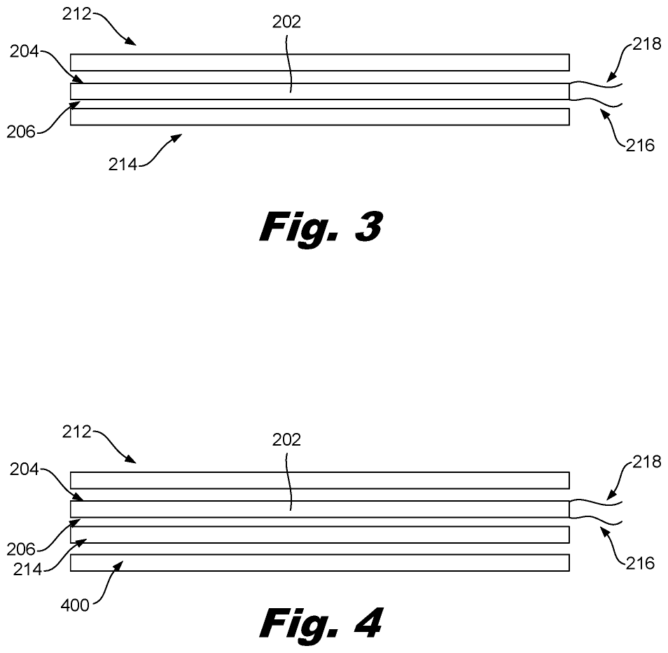

In some cases, the touch controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously. Electrodes may also be arranged in non-rectangular arrays, such as radial patterns, linear strings, or the like. A ground plane shield (see FIG. 3) may be provided beneath the electrodes to reduce noise or other interference. The shield may extend beyond the grid of electrodes. Other configurations are also possible.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the touch input component 200. The touch input component 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the touch input component 200, the touch controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the touch input component 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a touch pad. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a touch pad, the substrate 202 may be located between a touch surface 212 and a shield 214. The touch surface 212 may be a covering that is placed over the first side of the substrate 202 and that is at least partially transparent to electric fields. As a user's finger or stylus approach the touch surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the portable electronic device. This shield may prevent influence on the electric fields on the substrate 202.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

FIG. 4 depicts an example of a touch screen as the touch input controller. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display 400. The display 400 may be a layer of pixels or diodes that illuminate to generate an image. The display may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the touch surface 212 may all be at least partially transparent to allow the display to be visible to the user through the touch surface 212. Such a touch screen may be included in a monitor, a display assembly, a laptop, a mobile phone, a mobile device, an electronic tablet, another type of portable electronic device, or combinations thereof.

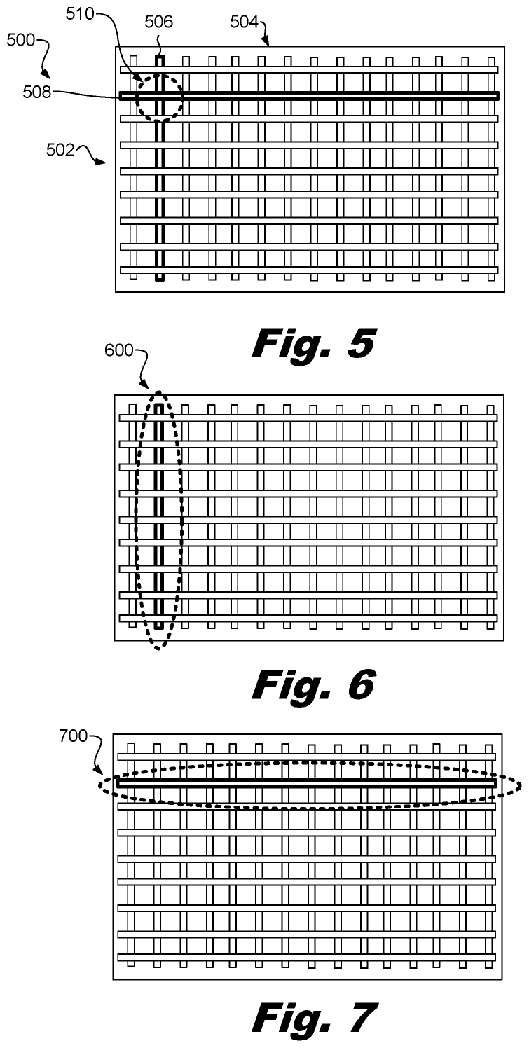

FIG. 5 depicts an example of a touch sensor 500. In this example, a first set 502 of electrodes is oriented in a Y-direction where each of the electrodes oriented in the Y-direction are substantially aligned with each other. Also, a second set 504 of electrodes is oriented in a X-direction where each of the electrodes oriented in the X-direction are substantially aligned with each other. In this example, the first set 502 of electrodes and the second set 504 of electrodes are oriented to be transverse to each other. For purposes of illustration, the first set 502 of electrodes and the second set 504 of electrodes are depicted next to each other, however, it should be understood that the first set 502 of electrodes and the second set 504 of electrodes are spaced apart from each other so that there is no electrical shorting. In some examples, the first set 502 of electrodes and the second set 504 of electrodes are separated by a substrate, a dielectric, another type of material, or combinations thereof which is not depicted in this example.

FIG. 5 depicts an example where a mutual capacitance sensing technique is used to detect an object. In this example, a first electrode 506 may be energized by applying a voltage to the first electrode 506. A second electrode 508 is used to measure a capacitance. The intersection 510 of the first electrode 506 and the second electrode 508 is circled and represents an area in which this the object is detectable. Although the first electrode 506 is energized and the entire second electrode is used to measure the changes in capacitance, the mutual capacitance measuring technique may be limited to a relatively small region around the intersection 510 where the object is detectable.

FIG. 6 depicts an example of using a self-capacitance measurement technique. In this example, an electrode 600 is energized by applying a voltage to the electrode 600. After energizing the electrode 600, the electrode 600 is also used to measure the capacitance. In this example, an object may be detected along the entire length of the electrode 600. In this example, the electrode 600 may be oriented in a Y-direction.

FIG. 7 depicts an example of using a self-capacitance measurement technique. In this example, an electrode 700 is energized by applying a voltage to the electrode 700. After energizing the electrode 700, the electrode 700 is also used to measure the capacitance. In this example, an object may be detected along the entire length of the electrode 700. In this example, the electrode 700 may be oriented in a X-direction.

FIG. 8 depicts an example of a user's hand 800 resting with respect to the touch sensor 802 in a position such that a portion of the user's hand is being held relatively stationary with respect to the touch sensor for a period of time. For purposes of illustration, the hand 800 appears directly over the electrodes of the touch sensor. However, in some examples, an overlay, a keyboard surface, a glass surface, another type of surface, or combinations thereof may be located between the user's hand 800 and the touch sensor 802, but are not illustrated in this depicted example.

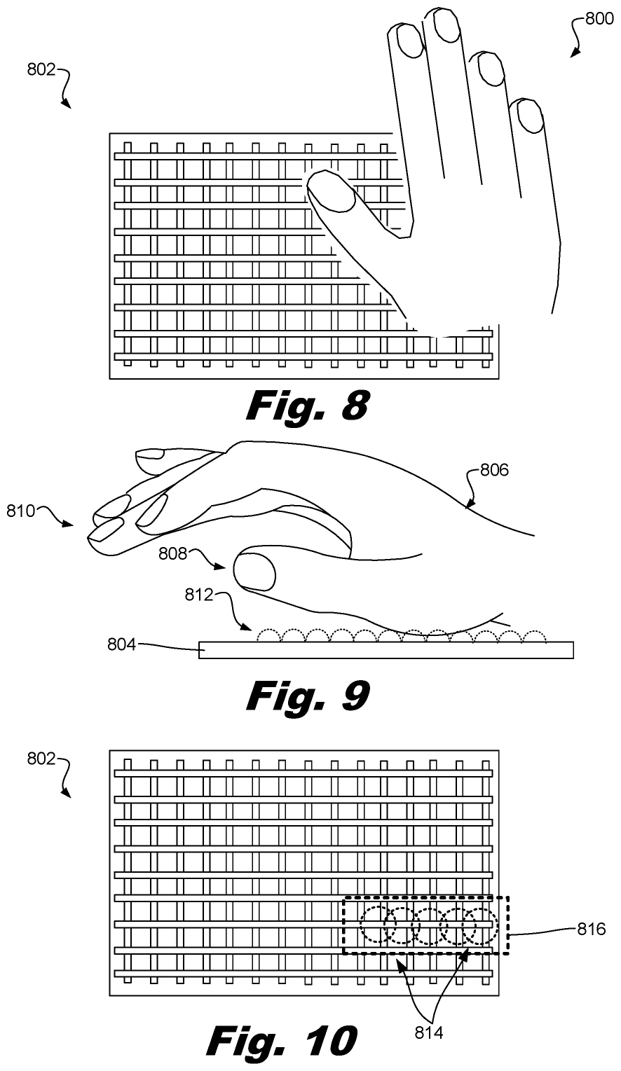

FIG. 9 depicts a side view of the hand illustrated in FIG. 8 as the hand may appear in relation to an overlay 804 or another type of touch surface. In this example, a mutual capacitance measuring technique may be used to detect the location of the user's hand 800. In this example, a palm 806 of the hand 800 may be closest to the touch sensor while the thumb 808 and the fingers 810 are raised at a higher elevation away from the touch sensor. In the depicted example, the z-axis detection range of the mutual capacitance sensing technique is depicted with dashed lines 812. In this example, just a portion of the user's palm is close enough to the touch sensor to be within the z-axis range of the mutual capacitance detection range while the other portions of the hand 800, including the thumb 808 and fingers 810 are out of this range.

FIG. 10 depicts an example of the electrode intersections 814 that detect the presence of the hand 800 from the depictions of FIGS. 8 and 9. As can be seen in FIG. 10, just a few electrode intersections 814 were capable of detecting the closest portions of the palm 806 of the hand 800. In this example, just the lowest portion of the palm 806 is detectable while the other portions of the hand 800 are outside of the z-axis detection range. Thus, to the detection system, the mutual capacitance perspective profile 816 of the hand 800 can be constructed based on the electrode intersections 814 that detected the palm 806. The system may construct a mutual capacitance perspective profile, which is represented in FIG. 10 with the dashed rectangle. Even though the hand 800 resting over the touch sensor 802 in FIGS. 8 and 9 overlaps with a much larger area of the touch sensor and is not rectangular in shape, from the perspective of the detection system, the mutual capacitance perspective profile is seen as having a smaller rectangular shape.

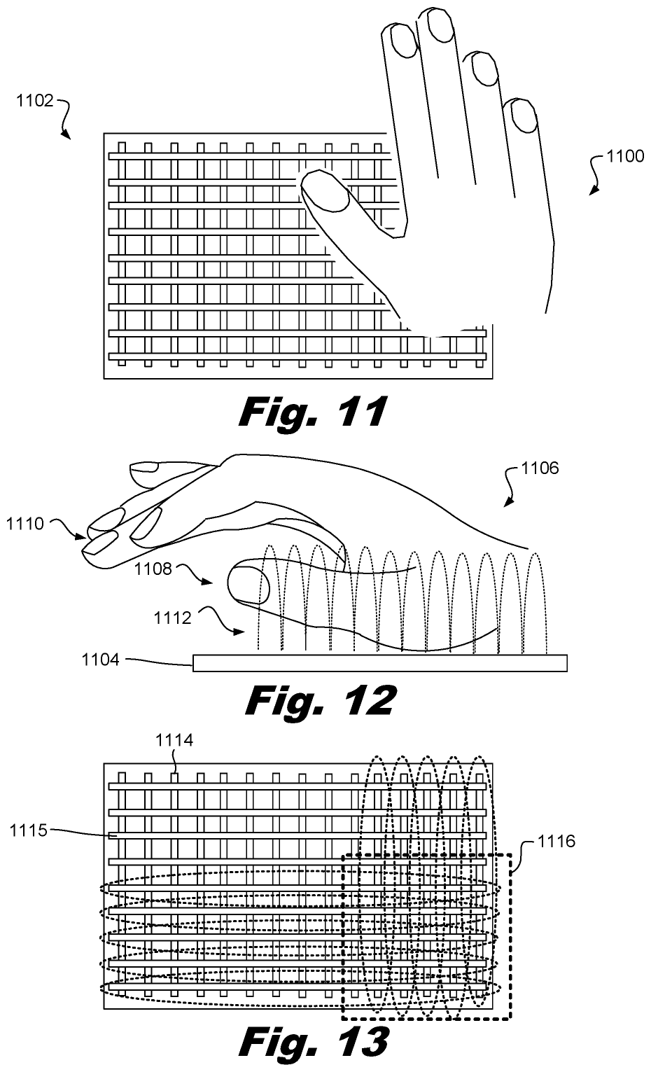

FIG. 11 depicts an example of a user's hand 1100 resting with respect to the touch sensor 1102 in a position such that a portion of the user's hand is being held relatively stationary with respect to the touch sensor for a period of time. In this example, the position of the hand 1100 is the same position as depicted in FIG. 8 covering the same area and coordinates (X, Y, and Z coordinates) as are covered in the example of FIGS. 8 and 9.

FIG. 12 depicts a side view of the hand illustrated in FIG. 11 as the hand may appear in relation to an overlay 1104 or another type of touch surface. In this example, a self-capacitance measuring technique may be used to detect the location of the user's hand 1100. In this example, a palm 1106 of the hand 1100 may be closest to the touch sensor while the thumb 1108 and the fingers 1110 are raised at a higher elevation away from the touch sensor. In the depicted example, the z-axis range of the self-capacitance sensing technique is depicted with dashed lines 1112. In this example, larger a portion of the user's palm is close enough to the touch sensor to be within the z-axis range of the self-capacitance detection range thereby detecting in a much larger amount of the user's hand.

FIG. 13 depicts an example of the electrodes 1114 in the Y-direction and the electrodes 1115 in the X-direction that detect the present of the hand 1100 from the depictions of FIGS. 11 and 12. As can be seen in FIG. 13, several rows of electrodes 1114 in the Y-direction and the electrodes 1115 in the X-direction detected portions of the palm 1106 of the hand 1100. In this example, more of the palm 806 is detectable than was detected in the example of FIGS. 8 and 9. Thus, to the detection system, the self-capacitance perspective profile 1116 of the hand 1100 can be constructed based on the several rows of electrodes 1114 in the Y-direction and the electrodes 1115 in the X-direction that detected the hand 1100. The system may construct a self-capacitance perspective profile 1116, which is depicted in FIG. 13 with the dashed rectangle and includes the overlapping areas of the Y-direction and X-direction electrodes 1114, 1115. Even though the hand 1100 resting over the touch sensor 1102 in FIGS. 11 and 12 covers the same coordinates as that depicted in FIGS. 8 and 9, the mutual capacitance perspective profile 816 and the self-capacitance perspective profile have a different shape and size. Thus, some information about the actual shape, actual size, and actual z-distance of the hand away from the touch sensor may be gleaned from the mutual capacitance perspective profile, while other information about the actual shape, actual size, and actual z-distance can be gleaned from the self-capacitance perspective profile.

By analyzing information from both the mutual capacitance perspective profile and the self-capacitance perspective profile, the system may make a determination about whether the hand is overlapping and resting with respect to the position of the touch sensor.

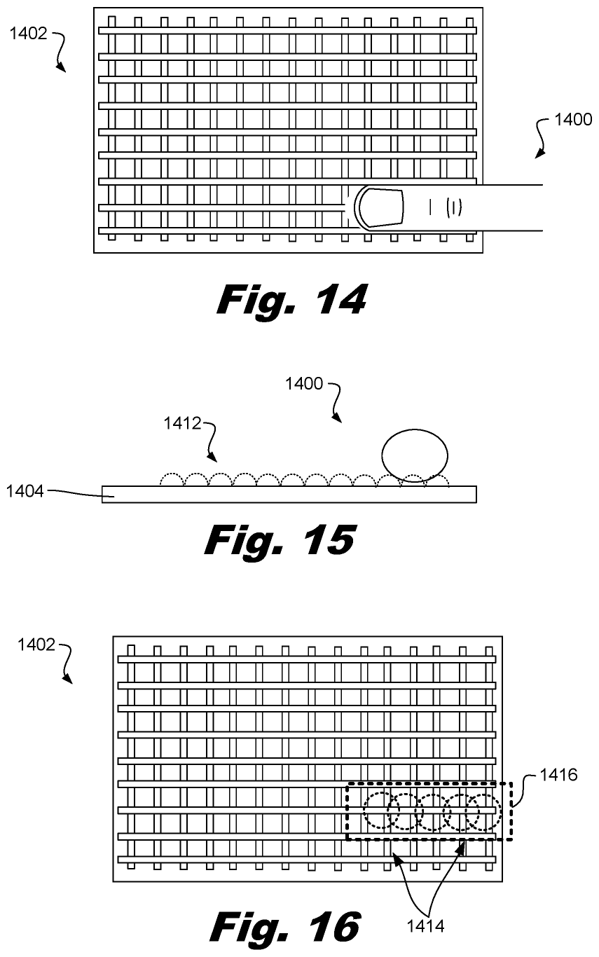

FIG. 14 depicts an example of a user's finger 1400 moving with respect to the touch sensor 1402 in a position such that a portion of the user's finger 1400 is being held relatively stationary with respect to the touch sensor 1402 for a period of time.

FIG. 15 depicts a side view of the finger 1400 illustrated in FIG. 14 as the finger 1400 may appear from the side in relation to an overlay 1404 or another type of touch surface. In this example, a mutual capacitance measuring technique may be used to detect the location of the user's finger 1400. In the depicted example, the z-axis detection range of the mutual capacitance sensing technique is depicted with dashed lines 1412. In this example, the user's entire finger 1400 that is over the touch sensor 1402 is close enough to the touch sensor to be within the mutual capacitance detection range.

FIG. 16 depicts an example of the electrode intersections 1414 that detect the presence of the finger 1400 from the depictions of FIGS. 14 and 15. In this example, to the detection system, the mutual capacitance perspective profile 1416 of the finger 1400 can be constructed based on the electrode intersections 1414 that detected the finger 1400. The system may construct a mutual capacitance perspective profile, which is represented in FIG. 16 with the dashed rectangle. From the perspective of the detection system in this particular example, the mutual capacitance perspective profile is seen as having about the same size as the FIG. 1400.

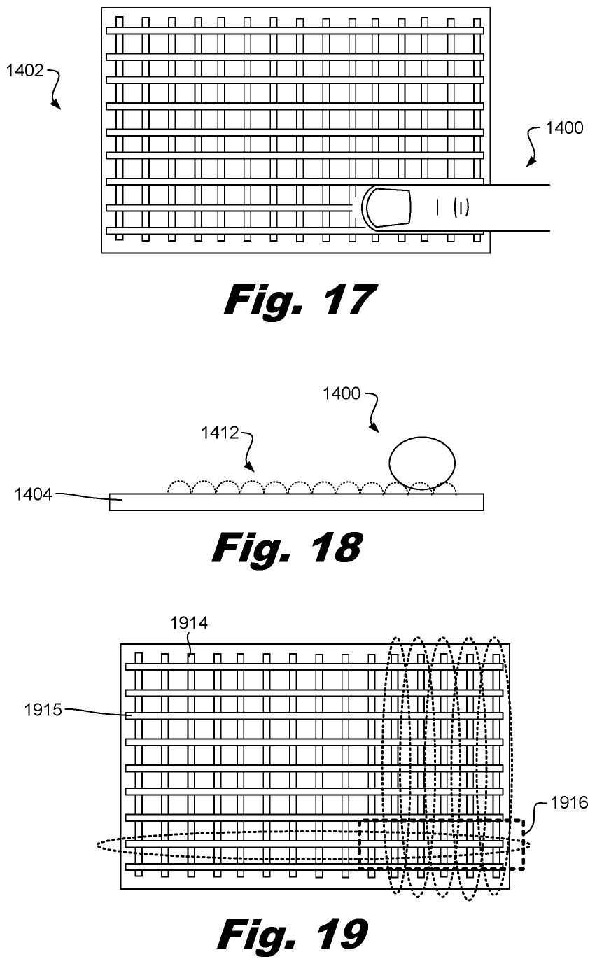

FIG. 17 depicts an example of a user's finger 1400 moving with respect to the touch sensor 1402 in a position such that a portion of the user's finger 1400 is being held relatively stationary with respect to the touch sensor 1402 for a period of time. In this example, the position of finger 1400 is the same position as depicted in FIG. 14 covering the same area and coordinates (X, Y, and Z coordinates) as are covered in the example of FIGS. 14 and 15.

FIG. 18 depicts a side view of the finger 1400 illustrated in FIG. 14 as the finger 1400 may appear in relation to an overlay 1404 or another type of touch surface. In this example, a self-capacitance measuring technique may be used to detect the location of the user's finger 1400. In the depicted example, the z-axis range of the self-capacitance sensing technique is depicted with dashed lines 1412. In this example, the user's finger 1400 is close enough to the touch sensor to be within the z-axis range of the self-capacitance detection range thereby detecting in a finger 1400 along the finger's entire length.

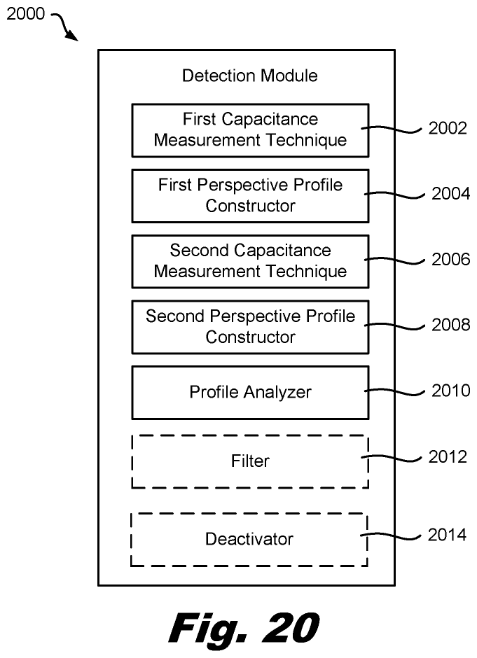

FIG. 19 depicts an example of the electrodes 1914 in the Y-direction and the electrodes 1915 in the X-direction that detect the present of the finger 1400 from the depictions of FIGS. 14 and 15. As can be seen in FIG. 16, several rows of electrodes 1914 in the Y-direction and the electrodes 1915 in the X-direction detected the finger 1400. In this example, the same amount of the finger 1400 is detectable as was detected in the example of FIGS. 14 and 15. Thus, to the detection system, the self-capacitance perspective profile 1916 of the finger 1400 can be constructed based on the several rows of electrodes 1914 in the Y-direction and the electrodes 1915 in the X-direction that detected the finger 1400. The system may construct a self-capacitance perspective profile 1916, which is represented in FIG. 19 with a dashed rectangle and includes the overlapping areas of the Y-direction and X-direction electrodes 1914, 1915. In this example, the finger 1400 resting over the touch sensor 1402 in FIGS. 16 and 17 covers the same coordinates as that depicted in FIGS. 14 and 15, the mutual capacitance perspective profile 1416 and the self-capacitance perspective profile 1916 have the same shape and size. In these very specific examples depicted in FIGS. 8-10, the mutual capacitance perspective profile for the palm of the hand and also the mutual capacitance perspective profile for the finger depicted in FIGS. 14-16 are the same shape and size. Thus, in some cases, different sized objects or actions of the user may be perceived by the system as being the same, when in reality they are not the same shape or size. The same may be true for self-capacitance measurement technique where objects of different shapes and sizes may appear to be the same when in reality, they are not. However, by analyzing both the mutual capacitance perspective profile and the self-capacitance perspective profile more information about the actual size and shape of the object interacting with the touch sensor can be determined. Thus, some information about the actual shape, actual size, and actual z-distance of the hand away from the touch sensor may be gleaned from the mutual capacitance perspective profile, while other information about the actual shape, actual size, and actual z-distance can be gleaned from the self-capacitance perspective profile.

By analyzing information from both the mutual capacitance perspective profile and the self-capacitance perspective profile, the system may make a determination about whether the hand is overlapping and resting with respect to the position of the touch sensor.

In the examples described in FIGS. 8-13 the palm of the hand was resting with respect to the touch sensor. In some cases, the palm may be resting when a user makes physical contact with an overlay by putting his or her hands on the overlay while using his or her fingers to operate the keyboard. In such instances, it may be undesirable to register the presence of the hand since the user is not intending to provide inputs through the touch sensor while operating the keyboard. In such an example, it may be desirable for the detecting system to send a message with instructions to deactivate a region of the touch sensor, deactivate the entire touch sensor, filter out the types of signals being determined to be a palm resting over the touch sensor, perform another action to negate unintended signals from the palm, perform another action, or combinations thereof. On the other hand, the finger movement depicted in FIGS. 14-19 might occur when a user is intending to make an input though the touch sensor. In such a circumstance, it would be inappropriate to negate the user's intended inputs. Thus, analyzing the different perspective profiles may allow the system to distinguish between palms resting over the touch sensor or other unintended inputs and those inputs that are intended by the user.

In some examples, the system may operate using a mutual capacitance measuring technique to identify inputs from a user. In the absence of detecting an object, the system may use just mutual capacitance to detect the object. However, in some examples, when the mutual capacitance system detects an object, the system may start to alternatingly switch between taking measurements using mutual capacitance and self-capacitance. In another example, the self-capacitance measurement technique is not used unless the mutual capacitance measurement technique identifies a perspective profile that has a probability of representing an object resting proximate the touch sensor. In such an example, the self-capacitance measurement technique is employed to confirm whether an object is resting proximate the touch sensor. In yet another example, the mutual capacitance measurement technique and self-capacitance measurement technique are used regardless of whether an object is identified, regardless of whether an object is suspected of resting proximate to the touch sensor, regardless of another condition, or combinations thereof. In yet other examples, a third capacitance measurement technique may be used with a mutual capacitance measurement technique, a self-capacitance measurement technique, or combinations thereof.

FIG. 20 depicts an example of a detection module 2000. In this example, the detection module 2000 includes programmed instructions in memory and may include associated firmware, logic, processing resources, memory resources, power sources, hardware, or other types of hardware to carry out the tasks of the palm detection module 2000. The detection module 2000 may be used in conjunction with the description of the devices, modules, and principles described in relation to FIGS. 1-19. In this example, the detection module 2000 includes a first capacitance measurement technique 2002, a first perspective profile constructor 2004, a second capacitance measurement technique 2006, a second perspective profile constructor 2008, and a profile analyzer 2010. Optionally, in just some examples, the detection module 2000 may include a filter 2012. Optionally, in just some examples, the detection module 2000 may include a deactivator 2014.

The first capacitance measurement technique 2002 may cause a mutual capacitance measuring technique, a self-capacitance measuring technique, or another type of capacitance measuring technique to be performed to detect an object proximate a touch sensor.

The first perspective profile constructor 2004 may use the electrodes that detect an object, the electrode intersections that detect an object, and/or combinations thereof to constructor a profile of the object proximate to the touch sensor. In some cases, the perspective profile includes a perspective shape, a perspective size, a perspective dimension, or another perspective attribute of the object.

The second capacitance measurement technique 2006 may cause a mutual capacitance measuring technique, a self-capacitance measuring technique, or another type of capacitance measuring technique to be performed to detect an object proximate a touch sensor.

The second perspective profile constructor 2008 may use the electrodes that detect an object, the electrode intersections that detect an object, and/or combinations thereof to construct a profile of the object proximate to the touch sensor. In some cases, the perspective profile includes a perspective shape, a perspective size, a perspective dimension, or another perspective attribute of the object.

The profile analyzer 2010 may analyze the first and second perspective profiles to determine the actual profile of the object. In examples where a third capacitance measurement technique or more are employed, the profile analyzer may construct additional perspective profiles. In some cases, analyzing the perspective profiles may include comparing the perspective profiles against each other and identifying differences between the profiles. In some cases, the first perspective profiles may be matched with similar profiles generated through the same first capacitance sensing technique that are stored in a database, lookup table, or other location while the second perspective profiles are matched with similar profiles generated through the same second capacitance sensing technique, and so forth. The profile analyzer 2010 may be used to determine whether the object is resting and therefore creating unintended user inputs through the touch sensor or whether the inputs are intended user inputs.

The filter 2012 may filter out those signals from objects who have perspective profiles that match unintended inputs, such as a palm resting over the touch sensor.

The deactivator 2014 may deactivate those regions of the touch sensor where the system determines that the inputs are unintended. In some cases, the entire touch sensor may be deactivated for a time when it is determined that the user's hands are resting over the touch sensor.

While the examples above have been described with reference to using just inputs from a capacitance touch sensor to determine whether an object is resting over the touch sensor or whether certain inputs are unintended, in some examples, the system may use additional inputs from outside of capacitance sensing to determine whether a palm is resting or whether the inputs are unintended. For example, in some cases, the system may determine whether the keyboard is receiving inputs from the user to help determine whether the hand is placed over the touch sensor but not intending to use the touch sensor. In some cases, the combination of the first perspective profile and the second perspective profile, in combination with keyboard inputs, may help determine whether an object is resting over the touch sensor.

In some cases, the system may also use subsequent user touch sensor inputs to determine whether the object was resting over the touch sensor. For example, in those cases that the system determines that an object is resting over the touch sensor and the system is wrong in this determination, the user may remake the input that were filtered out or deactivated. Upon recognizing that the canceled input is remade by the user, the system may learn that the detected perspective profiles match a circumstance where the user is making an intended input. Thus, the system may record the conditions for the profile analyzer to consider in future events. In other cases, where the system recognizes that it incorrectly determined to filter out or deactivate inputs, the system may lower a confidence score associated with those particular conditions and unintended inputs. In other examples, the system may make a determination that certain inputs were unintended and the user may not make any corrections. In such an example, the system may record this conditions to assist in future cases. In such an example, the system may increase its confidence score under those conditions that the inputs were unintended.

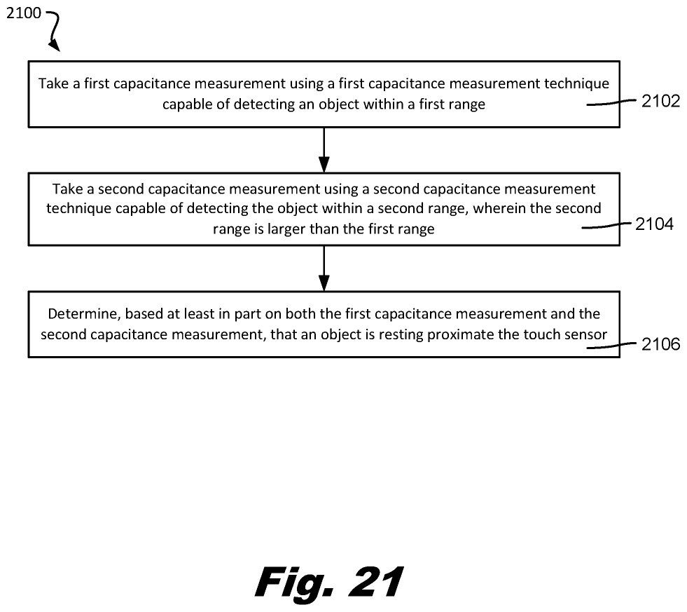

FIG. 21 depicts an example of a method 2100 for palm detection. This method 2100 may be performed based on the description of the devices, modules, and principles described in relation to FIGS. 1-20. In this example, the method 2100 includes taking 2102 a first capacitance measurement using a first capacitance measurement technique capable of detecting an object within a first range; taking 2104 a second capacitance measurement using a second capacitance measurement technique capable of detecting the object within a second range, wherein the second range is larger than the first range; and determining 2106, based at least in part on both the first capacitance measurement and the second capacitance measurement, that an object is resting proximate the touch sensor.

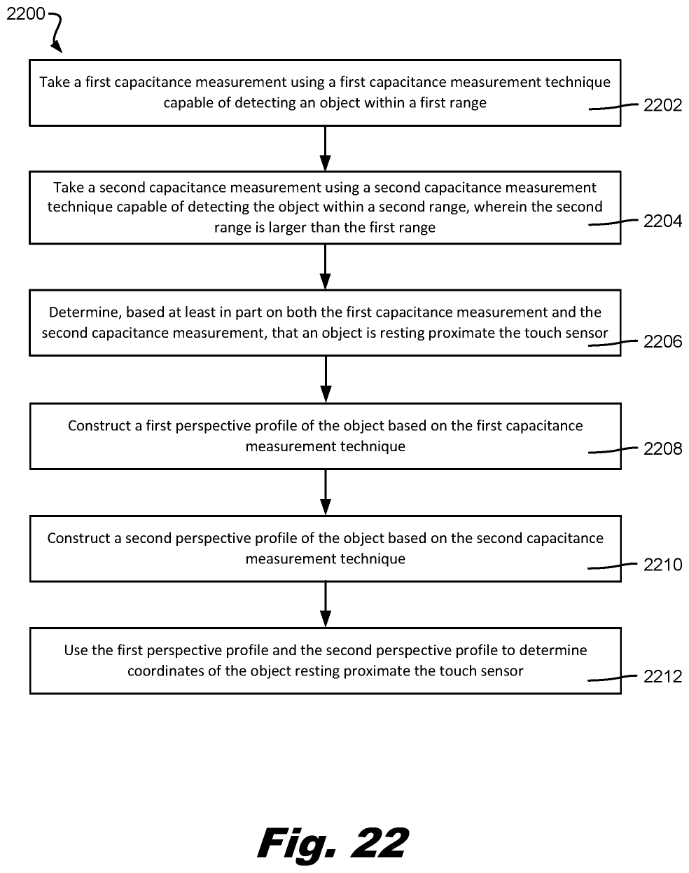

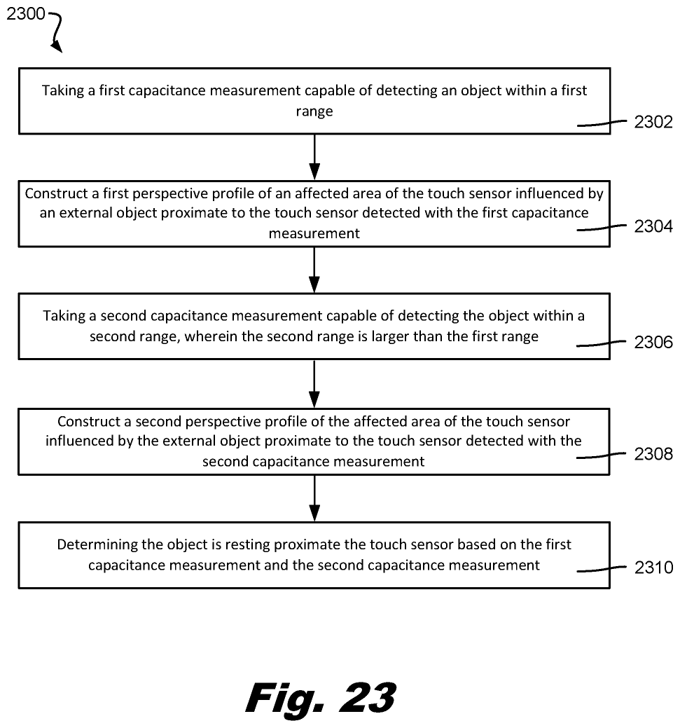

FIG. 22 depicts an example of a method 2200 for palm detection. This method 2200 may be performed based on the description of the devices, modules, and principles described in relation to FIGS. 1-20. In this example, the method 2200 includes taking 2202 a first capacitance measurement using a first capacitance measurement technique capable of detecting an object within a first range; taking 2204 a second capacitance measurement using a second capacitance measurement technique capable of detecting the object within a second range, wherein the second range is larger than the first range; determining 2206, based at least in part on both the first capacitance measurement and the second capacitance measurement, that an object is resting proximate the touch sensor; constructing 2208 a first perspective profile of the object based on the first capacitance measurement technique; constructing 2210 a second perspective profile of the object based on the second capacitance measurement technique; and analyzing 2212 the first perspective profile to the second perspective profile to determine whether the object is resting proximate the touch sensor.

FIG. 21 depicts an example of a method 2300 for palm detection. This method 2300 may be performed based on the description of the devices, modules, and principles described in relation to FIGS. 1-20. In this example, the method 2300 includes taking 2302 a first capacitance measurement capable of detecting an object within a first range, constructing 2304 a first perspective profile of an affected area of the touch sensor influenced by an external object proximate to the touch sensor detected with the first capacitance measurement, taking 2306 a second capacitance measurement capable of detecting the object within a second range, wherein the second range is larger than the first range, constructing 2308 a second perspective profile of the affected area of the touch sensor influenced by the external object proximate to the touch sensor detected with the second capacitance measurement, and determining 2310 the object is resting proximate the touch sensor based on the first capacitance measurement and the second capacitance measurement.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A touch sensor, including:
a substrate;
a first set of electrodes formed on a first layer of the substrate;
a second set of electrodes formed on a second layer of the substrate, where the first set and second set are spaced apart and electrically isolated from each other;
the first of electrodes and the second set of electrodes being in communication with a capacitance controller;
memory in communication with the capacitance controller where the memory includes programmed instructions that, when executed, cause the capacitance controller to:
take a first capacitance measurement using a first capacitance measurement technique capable of detecting an object within a first range;
take a second capacitance measurement using a second capacitance measurement technique capable of detecting the object within a second range, wherein the second range is larger than the first range; and
determine, based at least in part on both the first capacitance measurement and the second capacitance measurement, that an object is resting proximate the touch sensor.

2. The touch sensor of claim 1, wherein the programmed instructions, when executed, further cause the proximity controller to:
construct a first perspective profile of the object based on the first capacitance measurement technique;
construct a second perspective profile of the object based on the second capacitance measurement technique; and
analyze the first perspective profile to the second perspective profile to determine whether the object is resting proximate the touch sensor.

3. The touch sensor of claim 1, wherein the first capacitance technique is a mutual capacitance technique.

4. The touch sensor of claim 1, wherein the second capacitance technique is a self-capacitance technique.

5. The touch sensor of claim 4, wherein taking a self-capacitance measurement includes taking at least one measurement with at least one electrode from the first set of electrode and taking a self-capacitance measurement with at least one electrode from the set of electrodes.

6. The touch sensor of claim 5, wherein the first set of electrodes is configured to take a self-capacitance measurement in an X-direction and the second set of electrodes is configured to take a self-capacitance measurement in a Y-direction.

7. The touch sensor of claim 1, wherein the programmed instructions, when executed, further cause the proximity controller to determine that signals from the object resting proximate the touch sensor is not involved in a touch input.

8. The touch sensor of claim 1, wherein the programmed instructions, when executed, further cause the proximity controller to filter out signals from the object resting proximate the touch sensor.

9. The touch sensor of claim 1, wherein the programmed instructions, when executed, further cause the proximity controller to inactivate at least a portion of the touch pad when the object is resting proximate the touch pad.

10. A method of using a touch sensor, comprising:
taking a first capacitance measurement capable of detecting an object within a first range;
constructing a first perspective profile of an affected area of the touch sensor influenced by an external object proximate to the touch sensor detected with the first capacitance measurement;
taking a second capacitance measurement capable of detecting the object within a second range, wherein the second range is larger than the first range;
constructing a second perspective profile of the affected area of the touch sensor influenced by the external object proximate to the touch sensor detected with the second capacitance measurement; and
determining the object is resting proximate the touch sensor based on the first capacitance measurement and the second capacitance measurement.

11. The method of claim 10, wherein the first capacitance technique is a mutual capacitance measurement that includes measuring capacitance at least one intersection between a first set of electrodes in a grid of the touch sensor and a second set of electrodes in the grid, where the first set of electrodes is formed on a first layer of a substrate and the second set of electrodes is formed on a second layer of the substrate and the first set of electrodes and the second set of electrodes are spaced apart from each other and electrically isolated from each other.

12. The method of claim 10, wherein the second capacitance technique is a self-capacitance measurement.

13. The method of claim 12, wherein taking the self-capacitance measurement includes taking at least one measurement with at least one electrode from the first set of electrode and taking a self-capacitance measurement with at least one electrode from the set of electrodes.

14. The method of claim 13, wherein the first set of electrodes is configured to take a self-capacitance measurement in an X-direction and the second set of electrodes is configured to take a self-capacitance measurement in a Y-direction.

15. The method of claim 10, further including determining that the object resting proximate the touch sensor is not involved in a touch input.

16. The method of claim 10, further including filtering out signals from the object resting proximate the touch sensor.

17. The method of claim 10, further including inactivating at least a portion of the touch pad when the object is resting proximate the touch pad.

18. A computer-program product for using a capacitance sensor, the computer-program product comprising a non-transitory computer-readable medium storing instructions executable by a processor to:
take a first capacitance measurement using a first capacitance measurement technique capable of detecting an object within a first range;
take a second capacitance measurement using a second capacitance measurement technique capable of detecting the object within a second range, wherein the second range is larger than the first range; and
determine, based at least in part on both the first capacitance measurement and the second capacitance measurement, that an object is resting proximate the touch sensor.

19. The computer-program product of claim 18, wherein the instructions are executable by a processor to:
construct a first perspective profile of the object based on the first capacitance measurement technique;
construct a second perspective profile of the object based on the second capacitance measurement technique; and
use the first perspective profile and the second perspective profile to determine a coordinates of the object resting proximate the touch sensor.

20. The computer-program product of claim 18, wherein the first capacitance technique is a mutual capacitance technique, and the second capacitance technique is a self-capacitance technique.
